(19) United States
(12) Patent Application Publication
(10) Pub. No.: US 2020/0317010 A1
(43) Pub. Date: Oct. 8, 2020

(54) PORTABLE TRASH BIN CADDY

(71) Applicants: Michael Simmons, Boston, GA (US); Carolyn Simmons, Boston, GA (US)

(72) Inventors: Michael Simmons, Boston, GA (US); Carolyn Simmons, Boston, GA (US)

(21) Appl. No.: 16/840,924

(22) Filed: Apr. 6, 2020

Related U.S. Application Data
(60) Provisional application No. 62/919,970, filed on Apr. 8, 2019.

(51) Int. Cl. B60D 1/04; B60D 1/52

(52) U.S. Cl. CPC B60D 1/04; B60D 1/52

(57) ABSTRACT

A trash bin caddy may be removably coupled to a motor vehicle. A wheeled trash bin may then be removably coupled to a pair of hooks on the trash bin caddy for towed transport of the wheeled trash bin. The trash bin caddy is inserted between a trunk lid closure of a motor vehicle. A first lug assembly and a second lug assembly are disposed at opposed ends of a suspension strap. The first lug assembly having a pair of hooks disposed in a laterally spaced apart relation for engagement with a handle of the wheeled trash bin. The second lug assembly dimensioned to be captively retained within the trunk of the motor vehicle when drawn in abutment with a trunk closure.

### CROSS-REFERENCE TO RELATED APPLICATION

This application claims the benefit of priority of U.S. provisional application No. 62/919,970 filed Apr. 8, 2019, the contents of which are herein incorporated by reference.

### BACKGROUND OF THE INVENTION

The present invention relates generally to a portable trash bin caddy for transporting wheeled trash bins. More particularly, the present invention relates to a method of towing two-wheeled trans bins to curbside.

When a wheeled trash bin is moved from a dwelling location to a curbside for emptying by a garbage collection service, it's usually an unwanted chore. For this reason, the trash bins are often left at the curbside pickup site. Other trash bin carriers utilize a trailer hitch mounted to the motor vehicle. While these may be convenient for those that have a trailer, hitch mounted to their motor vehicle, it makes little sense to go through the expense of installing a hitch system on the motor vehicle for this purpose.

What is needed is a more efficient and safe way of moving a two-wheeled trash bin between the curbside location, for garbage pickup, and a dwelling side location, where the trash bin may be conveniently filled.

### SUMMARY OF THE INVENTION

In one aspect of the present invention, a trash bin caddy for coupling a wheeled trash bin for transport with a motor vehicle is disclosed. The trash bin caddy including a pair of lug assemblies interconnected by a suspension strap. Each of the pair of lug assemblies have an elongate shaft. A padded sleeve encloses a median portion of the elongate shaft. A pair of hooks are disposed in a spaced apart relation and are carried by a first of the pair of lug assemblies. The pair of hooks are configured for cooperative engagement with a handle of the wheeled trash bin. A suspension strap interconnects the pair of lug assemblies in a spaced apart relation, wherein a first of the pair of lug assemblies is dimensioned to be captively retained by a trunk closure of the motor vehicle.

In some embodiments, an endcap is disposed on each of a first end and a second end of the elongate shaft.

In other embodiments, a loop is defined at an end of the suspension strap to rotationally retain the first end and the second end of the of the elongate shaft. The loop is carried on an intermediate portion of the elongate shaft between the endcap and the padded sleeve. In some embodiments, a fastener secures the loop in a closed condition about the elongate shaft.

In some embodiments, an adjustment buckle couples the first of the pair of lug assemblies to the suspension strap, such that a height of the pair of hooks can be adjusted while the trunk closure is in a closed condition.

In other embodiments, a retaining strap has a first end attached to a second of the pair of lug assemblies. An attachment is provided at a second end, the attachment is configured to secure the second end of the retaining strap to the motor vehicle.

In yet other embodiments, the attachment is a patch of Velcro for securing the second end to an interior liner of the trunk of the motor vehicle.

In other aspects of the invention, a method of transporting a wheeled trash bin is disclosed. The method includes inserting a trash bin caddy between a trunk lid closure of a motor vehicle. The trash bin caddy has a first lug assembly and a second lug assembly disposed at opposed ends of a suspension strap. The first lug assembly has a pair of hooks disposed in a laterally spaced apart relation. The second lug assembly is dimensioned to be captively retained within the trunk of the motor vehicle when drawn in abutment with a trunk closure.

In some embodiments, the method includes coupling a handle of the wheeled trash bin to the pair of hooks. The wheeled trash bin may then be when coupled with the motor vehicle. The wheeled trash bin may be uncoupled from the pair of hooks after the wheeled trash bin has been transported to a desired location.

These and other features, aspects and advantages of the present invention will become better understood with reference to the following drawings, description and claims.

### BRIEF DESCRIPTION OF THE DRAWINGS

FIG. 1 is a side view showing the trash bin caddy in-use;

FIG. 2 is a partial in-use perspective view of the trash bin caddy;

FIG. 3 is a section view taken along line 3-3 in FIG. 2;

FIG. 4 is a plan view of the trash bin caddy;

FIG. 5 is a section taken along line 5-5 in FIG. 4;

FIG. 6 is a section taken along line 6-6 in FIG. 4;

FIG. 7 is a section taken along line 7-7 in FIG. 4; and

FIG. 8 is a section taken along line 8-8 in FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an improved carrier or caddy for transporting a wheeled trash bin from a location proximal to a dwelling to a curbside pickup site, where the contents may be collected by a garbage collection service.

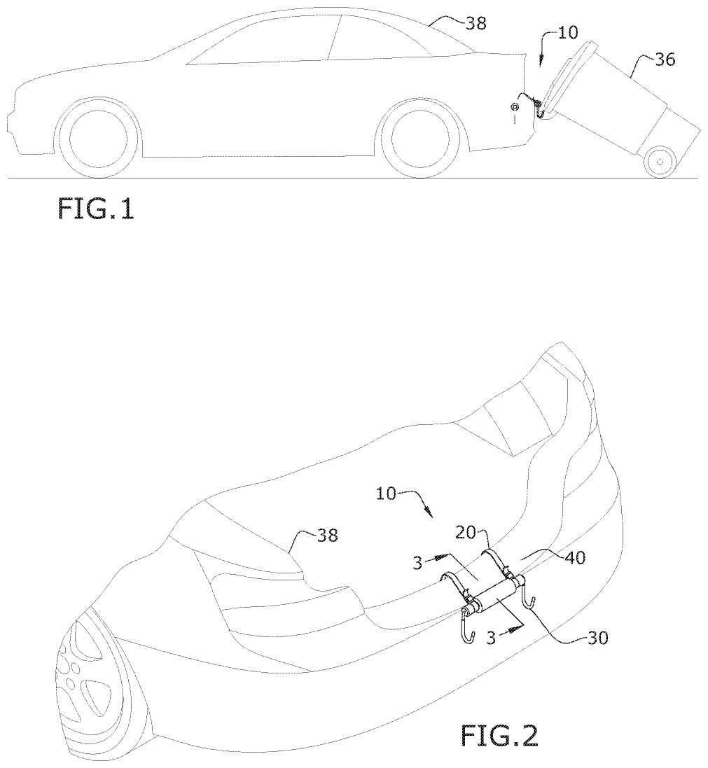

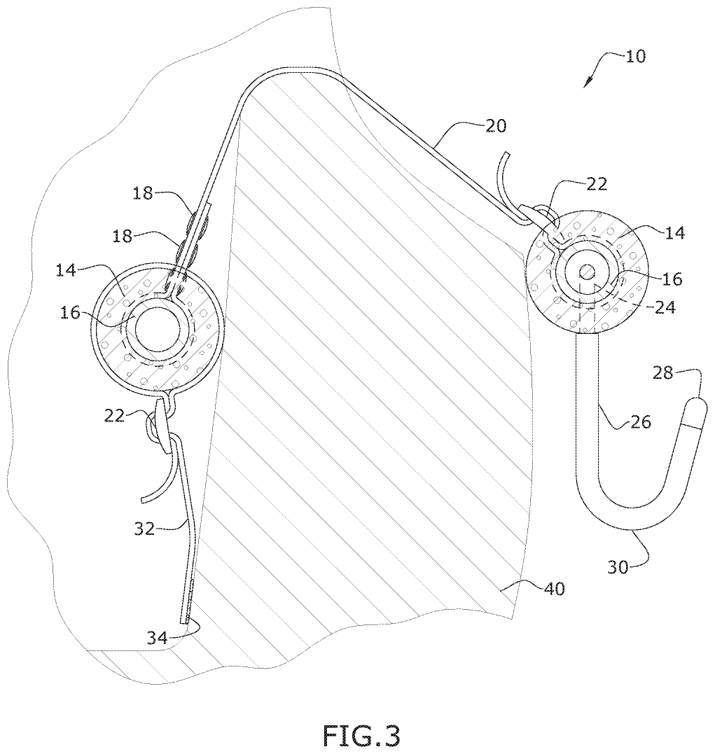

As seen in reference to the drawings of FIGS. 1 and 3, a trash bin caddy 10 according to aspects of the present invention may be coupled to a motor vehicle 38. A wheeled trash bin 36 may then be removably coupled to the trash bin caddy 10. The trash bin 36 may then be conveniently transported between a storage area proximal to a dwelling, where it may be readily loaded with garbage containment bags from within the dwelling, and a curbside pickup location, where the wheeled trash bin 38 may be collected by the garbage collection service.

In the non-limiting embodiment shown, the motor vehicle 38 is an automobile and the trash bin caddy 10 may be coupled to the motor vehicle 38 by retaining the trash bin caddy 10 in a trunk opening and securing it with closure of the trunk lid. Other motor vehicles, such as all-terrain vehicles (ATVs), golf carts, lawn tractors, and the like may also be utilized.

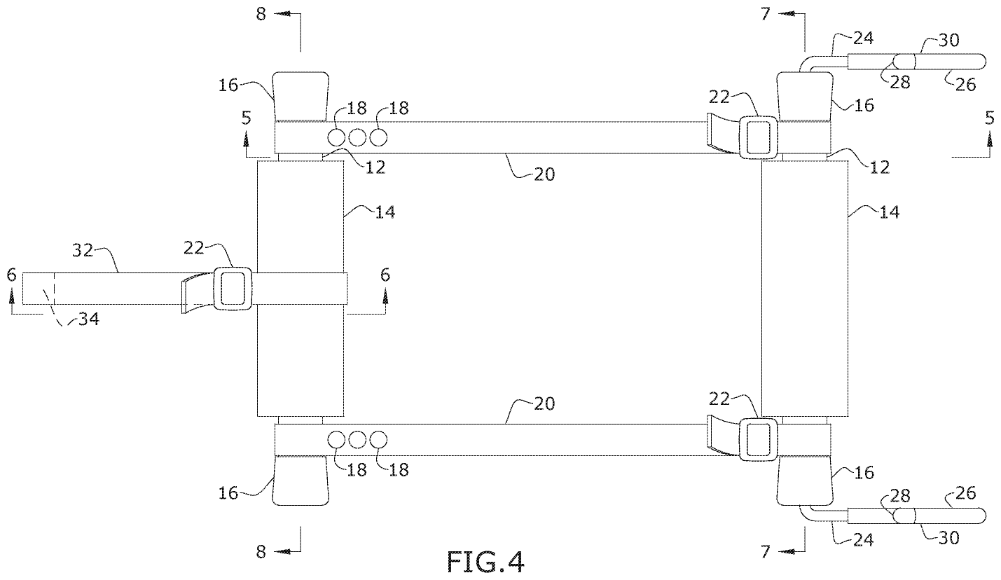

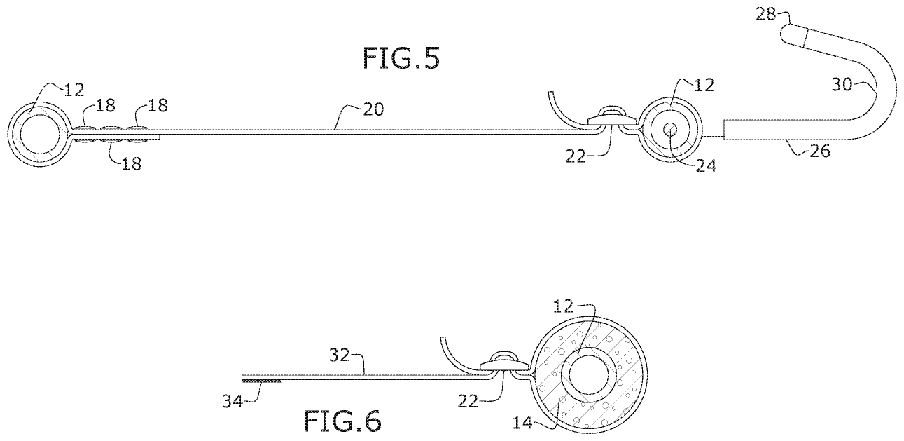

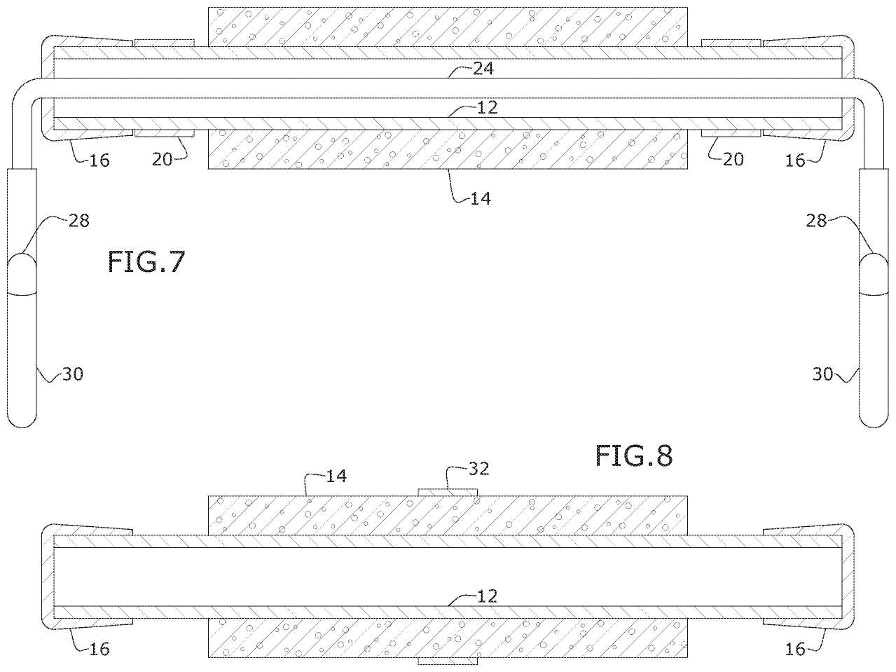

As seen in reference to the drawings of FIGS. 4-8, the trash bin caddy 10 of the present invention includes a pair of hooks 26 that are disposed in a spaced apart relation when suspended from an aft end of the motor vehicle 38. The spaced apart relation facilitates the lateral stability of the wheeled trash bin 38, when towed by the motor vehicle 38. The pair of hooks 30 engage with a handle of the wheeled trash bin 36. The par of hooks 26 may be interconnected by an elongate rod 24. The pair of hooks 26 and the elongate rod 24 are preferably made of a steel or high strength plastics. In some embodiments, the pair of hooks 26 and elongate rod 24 may be formed as a unitary component. A rubberized coating 30 may be provided over the hooks 26.

The trash bin caddy 10 has a pair of lug assemblies that are interconnected by a suspension strap 20. Each of the pair of lug assemblies include an elongate shaft 12, such as a length of PVC pipe. A median portion of the elongate shaft 12 is enclosed with a padded sleeve 14, to prevent marring of the finished surfaces of the motor vehicle 38. An end cap 16 may be disposed at opposed ends of the elongate shaft 12 to prevent marring of the finished surfaces of the motor vehicle. The elongate rod 24 may be carried within one of the pair of lug assemblies.

The suspension strap 20 interconnecting the pair of lug assemblies has a first end and a second end. The first end of the strap 20 is coupled to one of the pair of lug assemblies via a loop that is dimensioned to rotatably retain the first end of the strap 20 on an intermediate portion of the elongate shaft 12 between the end cap 16 and the padded sleeve 14 so that the first lug may automatically align with an orientation of the strap 20 when retained between the trunk lid and a trunk threshold 40. The strap loop may be secured by one or more fasteners 18, such as a rivet, a stitch, a screw, an adhesive, or a weldment. A second end of the strap 20 may also define a loop to rotatably retain the second lug assembly. The second end of the strap 20 includes a buckle 22 that is configured to adjust a length of the strap 20 to adjust a separation distance between the first lug assembly and the second lug assembly so that the trash bin caddy 10 may be adjustably fitted to varying dimensions of the trunk lid and the trunk threshold 40.

A retaining strap 32 may be fitted to the second lug assembly. The retaining strap 32 is configured to retain the trash bin caddy 10 in position on the trunk threshold 40 of the motor vehicle 38 in the event the operator opens the trunk lid. The retaining strap 32 has an attachment 34, such as a Velcro® patch, a, buckle, a, clamp, or the like, that is configured to cooperatively engage with an interior lining, such as a carpet, or elastomeric material on an interior of the trunk compartment. The attachment 34 may also connect the retaining strap 32 to a structural member of the motor vehicle.

The retaining strap 32 has a loop defined at the second end to encircle the padded layer 14 of the second lug assembly. A buckle 22 is provided to adjust the length of the retaining strap 34 and an attachment point on the interior of the trunk and position the first lug at a desired position on the trunk threshold 40. The retaining strap 32 may also include a fastener 34 that may be utilized to secure the trash bin caddy 10 to a structural component of the motor vehicle 38.

In use, the trunk caddy 10 straps 20 are suspended over the trunk threshold 40 so that the second lug assembly is positioned on an interior of the trunk cavity and the first lug assembly is positioned on an exterior of the motor vehicle and the trunk lid may be closed without interference. The first lug assembly is pulled so that the second lug assembly is positioned in abutment with the interior interface of the trunk lid and the trunk threshold 40.

The length of the straps 20 are adjusted so that the hooks 26 carried by the second lug assembly are suspended at a desired vertical clearance to tow the wheeled trash bin 36 by the hooks 26. For a two wheeled trash bin 36, the trash bin 36 will likely need to be tilted so that its center of gravity is carried forwardly towards the trash bin carrier 10, so that the wheeled trash bin 36 is retained on the hooks 26. With the trash bin 36 tilted onto the trash bin caddy's 10 hooks 26 and is automatically secured in place by gravity, Once wheeled trash bin is towed to desired location, pulling upwards on the trash bin handle releases the wheeled trash bin to an upright position.

The trash bin caddy 10 of the present invention is an easily attached to and released from the handle of the wheeled trash bin 36 and caddy hooks 26 that is designed to provide effortless movement of two-wheeled wheelie bins 36. In any instance, the present invention will successfully provide less handling of two-wheeled trash bins 36, therefore, providing safety and ease of movement. This invention does not have any moving parts it is held in place by trunk lid or hatchback closure, therefore making it easy to install and leave safely in place.

If desired, the trash bin caddy 10 can be easily stored inside by lifting trunk lid or opening hatchback and place inside and removed in reverse. As indicated, the present invention does not need a hitch ball or pin hookup on the motor vehicle and can be installed and left in place in all kinds of weather. Although there have been other inventions related to two-wheeled trash bin caddies, none of these inventions has successfully provided a means of portability and ease of installation and removal as the trash bin caddy 10.

It should be understood, of course, that the foregoing relates to exemplary embodiments of the invention and that modifications may be made without departing from the spirit and scope of the invention as set forth in the following claims.

What is claimed is:

1. A trash bin caddy for coupling a wheeled trash bin for transport with a motor vehicle comprising:
a pair of lug assemblies interconnected by a suspension strap; each of the pair of lug assemblies having an elongate shaft;
a padded sleeve enclosing a median portion of the elongate shaft;
a pair of hooks disposed in a spaced apart relation and carried by a first of the pair of lug assemblies, the pair of hooks configured for cooperative engagement with a handle of the wheeled trash bin; and
a suspension strap interconnecting the pair of lug assemblies in a spaced apart relation wherein a first of the pair of lug assemblies is dimensioned to be captively retained by a trunk closure of the motor vehicle.

2. The trash bin caddy of claim 1, further comprising:
an endcap disposed on each of a first end and a second end of the elongate shaft.

3. The trash bin caddy of claim 2, further comprising:
a loop defined at an end of the suspension strap to rotationally retain the first end and the second end of the of the elongate shaft.

4. The trash bin caddy of claim 3, wherein the loop is carried on an intermediate portion of the elongate shaft between the endcap and the padded sleeve.

5. The trash bin caddy of claim 4, further comprising:
a fastener securing the loop in a closed condition about the elongate shaft.

6. The trash bin caddy of claim 1, further comprising:
an adjustment buckle coupling the first of the pair of lug assemblies to the suspension strap, such that a height of the pair of hooks can be adjusted while the trunk closure is in a closed condition.

7. The trash bin caddy of claim 1, further comprising:
a retaining strap, having a first end attached to a second of the pair of lug assemblies, and an attachment at a second end, the attachment configured to secure the second end of the retaining strap to the motor vehicle.

8. The trash bin caddy of claim 7, wherein the attachment is a patch of Velcro for securing the second end to an interior liner of the trunk of the motor vehicle.

9. A method of transporting a wheeled trash bin, comprising:
inserting a trash bin caddy between a trunk lid closure of a motor vehicle, the trash bin caddy having a first lug assembly and a second lug assembly disposed at opposed ends of a suspension strap, the first lug assembly having a pair of hooks disposed in a laterally spaced apart relation, the second lug assembly dimensioned to be captively retained within the trunk of the motor vehicle when drawn in abutment with a trunk closure.

10. The method of claim 9, further comprising:
coupling a handle of the wheeled trash bin to the pair of hooks.

11. The method of claim 10, further comprising:
pulling the wheeled trash bin when coupled with the motor vehicle.

12. The method of claim 10, further comprising:
uncoupling the wheeled trash bin from the pair of hooks after the wheeled trash bin has been transported to a desired location.
